(19) United States
(12) Patent Application Publication
(10) Pub. No.: US 2023/0214745 A1
(43) Pub. Date: Jul. 6, 2023

(54) METHOD FOR MANAGING ALLOCATION OF VEHICLES TRAVELING TO DESTINATIONS, MANAGEMENT SERVER USED FOR SAME, AND RECORDING MEDIUM IN WHICH RECORDING PROGRAM THAT EXECUTES METHOD FOR MANAGING ALLOCATION OF VEHICLES TRAVELING TO DESTINATIONS IS RECORDED

(71) Applicant: 42DOT INC., Seoul (KR)

(72) Inventor: Ji Seong KIM, Yongin (KR)

(21) Appl. No.: 18/000,535

(22) PCT Filed: Jun. 2, 2021
(86) PCT No.: PCT/KR2021/006894

§ 371 Date: Dec. 2, 2022

(30) Foreign Application Priority Data
Jun. 3, 2020 (KR) 10-2020-0067097

(51) Int. Cl. G06Q 10/0631; G06Q 10/02; G06Q 50/30

(52) U.S. Cl. CPC G06Q 10/06314; G06Q 10/06315; G06Q 10/02; G06Q 50/30

(57) ABSTRACT

Provided are an allocation management method for a vehicle being driven to an arrival point, a management server used therefor, and a recording medium having recorded thereon a program for executing the allocation management method for a vehicle being driven to an arrival point. The present disclosure is implemented via processes by which a management server receives, from a driver terminal, driving information including current location information of an operating vehicle and arrival point information of the operating vehicle, receives, from a passenger terminal, passenger information including departure point information and destination information of a passenger, and determines whether matching between the operating vehicle and the passenger is suitable, based on the driving information and the passenger information. According to the present disclosure, efficiency of a vehicle operation may be increased as much as possible by determining vehicle allocation according to the driving information of the vehicle being driven towards an arrival point, the departure point and destination information of the passenger who requested a vehicle call, and a matching condition during allocation set by a vehicle driver.

### TECHNICAL FIELD

The present disclosure relates to an allocation management method for a vehicle being driven to an arrival point, a management server used therefor, and a recording medium having recorded thereon a program for executing the allocation management method for a vehicle being driven to an arrival point, and more particularly, to an allocation management method for a vehicle being driven to an arrival point, wherein not only efficiency of a vehicle operation may be increased as much as possible by determining vehicle allocation according to driving information of the vehicle being driven towards the arrival point, departure point and destination information of a passenger who requested a vehicle call, and a matching condition during allocation set by a vehicle driver, but also a vehicle standby time of the passenger may be minimized by comparing the driving information of the vehicle being currently driven with driving information of a standing-by vehicle to determine the vehicle allocation, a management server used therefor, and a recording medium having recorded thereon a program for executing the allocation management method for a vehicle being driven to an arrival point.

### BACKGROUND ART

With the widespread of vehicle call services, such as Kakao Taxi, Tada, and the like, passengers are able to call vehicles via a convenient method through smart phones to move to destinations.

Meanwhile, in order to guarantee profits of vehicle drivers through such vehicle call services via a network, it is necessary to minimize cases where the vehicles are driven empty, such as wandering without a passenger.

Nevertheless, the drivers of the vehicle call services mostly drive empty vehicles without a passenger when returning to garages or their houses after finishing a day's driving work.

In order to improve such an issue, Korean Patent Registration No. 10-2072174 proposes a method, performed by a compulsory allocation server, of receiving information about a business end time of each driver, receiving an expected driving route including departure point and destination information from a passenger, and compulsorily allocating the received expected driving route to each standing-by driver, in consideration of a remaining business time and a return time to a garage of each driver.

However, according to such a method, compulsory allocation is performed according to a standard set in the compulsory allocation server, and thus it is not possible for a vehicle driver to be involved in individual conditions to be considered during allocation determination.

In addition, in a vehicle call service of the related art, allocation is performed centering around drivers of vehicles standing by without carrying a passenger.

However, depending on situations, there may be a case where a driver of a vehicle being driven with a passenger may additionally perform driving for another passenger without substantially affecting a current driving route.

In addition, even for a driver of a vehicle being currently driven with a passenger, when a current destination is adjacent to a departure point of a passenger who requested a vehicle call, the driver may finally arrive at the departure point of the corresponding passenger before a driver of a standing-by vehicle, after completing the current driving.

Accordingly, there is a need to provide a vehicle allocation service considering moving route information of a vehicle being currently driven with a passenger.

### DESCRIPTION OF EMBODIMENTS

### Technical Problem

The present disclosure is directed to providing an allocation management method for a vehicle being driven to an arrival point, wherein not only efficiency of a vehicle operation may be increased as much as possible by determining vehicle allocation according to driving information of the vehicle being driven towards the arrival point, departure point and destination information of a passenger who requested a vehicle call, and a matching condition during allocation set by a vehicle driver, but also a vehicle standby time of the passenger may be minimized by comparing the driving information of the vehicle being currently driven with driving information of a standing-by vehicle to determine the vehicle allocation, a management server used therefor, and a recording medium having recorded thereon a program for executing the allocation management method for a vehicle being driven to an arrival point.

### Solution to Problem

According to the present disclosure, an allocation management method for a vehicle being driven to an arrival point, includes: receiving, by a management server, driving information including current location information of an operating vehicle and arrival point information of the operating vehicle, from a driver terminal; receiving, by the management server, passenger information including departure point information and destination information of a passenger, from a passenger terminal; and determining, by the management server, whether matching between the operating vehicle and the passenger is suitable, based on the driving information and the passenger information.

The determining may include determining, by the management server, whether a difference value between a total estimated travel time obtained by adding an estimated travel time from a current location to the operating vehicle to a departure point of the passenger, an estimated travel time from the departure point of the passenger to a destination of the passenger, and an estimated travel time from the destination of the passenger to an arrival point of the operating vehicle, and an estimated travel time from the current location of the operating vehicle to the arrival point of the operating vehicle is less than a predetermined reference value.

The determining may further include determining, by the management server, whether the estimated travel time from the current location of the operating vehicle to the departure point of the passenger is less than a predetermined reference value.

The determining may further include determining, by the management server, whether a distance from the destination of the passenger to the arrival point of the operating vehicle is less than a predetermined reference value.

According to the present disclosure, a management server includes: a receiving unit configured to receive, from a driver terminal, driving information including current location information of an operating vehicle and arrival point information of the operating vehicle, and receive, from a passenger terminal, passenger information including departure point information and destination information of the passenger; and a determining unit configured to determine whether matching between the operating vehicle and the passenger is suitable, based on the driving information and the passenger information.

The determining unit may be further configured to determine whether a difference value between a total estimated travel time obtained by adding an estimated travel time from a current location to the operating vehicle to a departure point of the passenger, an estimated travel time from the departure point of the passenger to a destination of the passenger, and an estimated travel time from the destination of the passenger to an arrival point of the operating vehicle, and an estimated travel time from the current location of the operating vehicle to the arrival point of the operating vehicle is less than a predetermined reference value.

The determining unit may be further configured to determine whether the estimated travel time from the current location of the operating vehicle to the departure point of the passenger is less than a predetermined reference value.

The determining unit may be further configured to determine whether a distance from the destination of the passenger to the arrival point of the operating vehicle is less than a predetermined reference value.

According to the present disclosure, an allocation management method for a vehicle being driven to an arrival point, includes: receiving, by a driver terminal, passenger information including departure point information and destination information of a passenger, from a management server; and determining, by the driver terminal, whether to approve boarding of the passenger, based on the passenger information and driving information including current location information of an operating vehicle driven by a driver and arrival point information of the operating vehicle.

The determining may include determining, by the driver terminal, whether a difference value between a total estimated travel time obtained by adding an estimated travel time from a current location to the operating vehicle to a departure point of the passenger, an estimated travel time from the departure point of the passenger to a destination of the passenger, and an estimated travel time from the destination of the passenger to an arrival point of the operating vehicle, and an estimated travel time from the current location of the operating vehicle to the arrival point of the operating vehicle is less than a predetermined reference value.

The determining may further include determining, by the driver terminal, whether the estimated travel time from the current location of the operating vehicle to the departure point of the passenger is less than a predetermined reference value.

The determining may further include determining, by the driver terminal, whether a distance from the destination of the passenger to the arrival point of the operating vehicle is less than a predetermined reference value.

According to the present disclosure, a recording medium has recorded thereon a program for executing the method.

### Advantageous Effects of Disclosure

According to the present disclosure, efficiency of a vehicle operation can be increased as much as possible by determining vehicle allocation according to driving information of a vehicle being driven towards an arrival point, departure point and destination information of a passenger who requested a vehicle call, and a matching condition during allocation set by a vehicle driver.

In addition, according to the present disclosure, a vehicle standby time of a passenger can be minimized by comparing driving information of a vehicle being currently driven with driving information of a standing-by vehicle to determine vehicle allocation.

### BRIEF DESCRIPTION OF DRAWINGS

FIG. 1 is a configuration diagram of an allocation management system for a vehicle being driven to an arrival point, according to an embodiment of the present disclosure.

FIG. 2 is a functional block diagram showing a structure of a management server for executing an allocation management method for a vehicle being driven to an arrival point, according to an embodiment of the present disclosure.

FIG. 3 is a signal flow diagram for describing an execution process of an allocation management method for a vehicle being driven to an arrival point, according to an embodiment of the present disclosure.

FIG. 4 is a conceptual diagram for describing an execution principle of an allocation management method for a vehicle being driven to an arrival point, according to an embodiment of the present disclosure.

FIG. 5 is a signal flow diagram for describing an execution process of an allocation management method for a vehicle being driven to an arrival point, according to another embodiment of the present disclosure.

FIG. 6 is a conceptual diagram for describing an execution principle of an allocation management method for a vehicle being driven to an arrival point, according to another embodiment of the present disclosure.

FIG. 7 is a block diagram of a management server according to an embodiment.

### BEST MODE

Provided are an allocation management method for a vehicle being driven to an arrival point, a management server used therefor, and a recording medium having recorded thereon a program for executing the allocation management method for a vehicle being driven to an arrival point. The present disclosure is implemented via processes by which a management server receives, from a driver terminal, driving information including current location information of an operating vehicle and arrival point information of the operating vehicle, receives, from a passenger terminal, passenger information including departure point information and destination information of a passenger, and determines whether matching between the operating vehicle and the passenger is suitable, based on the driving information and the passenger information. According to the present disclosure, efficiency of a vehicle operation may be increased as much as possible by determining vehicle allocation according to the driving information of the vehicle being driven towards an arrival point, the departure point and destination information of the passenger who requested a vehicle call, and a matching condition during allocation set by a vehicle driver.

### MODE OF DISCLOSURE

Hereinafter, the present disclosure will be described in detail with reference to accompanying drawings. It should be noted that like components in the drawings are denoted by like reference numerals wherever possible. In addition, detailed descriptions about well-known functions and configurations that may unnecessarily obscure the gist of the present disclosure are omitted.

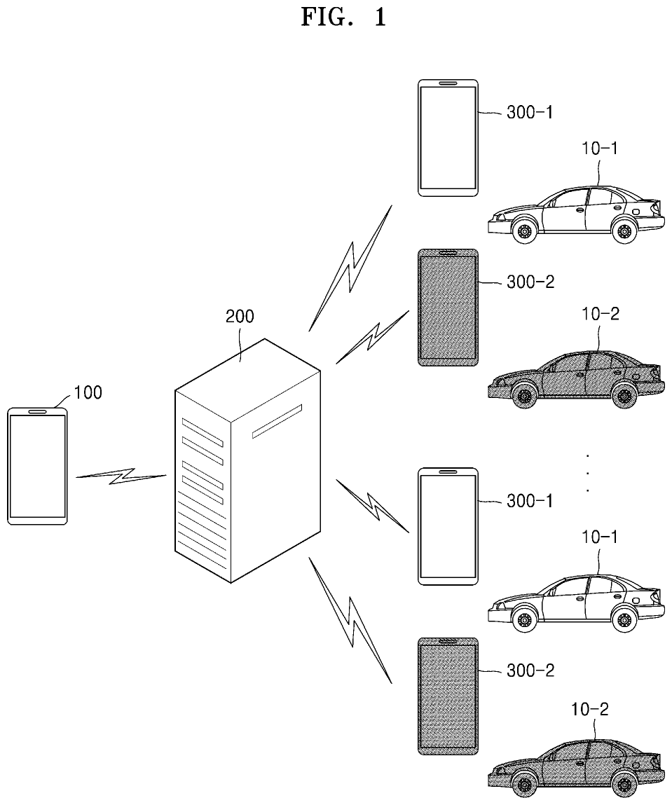

FIG. 1 is a configuration diagram of an allocation management system for a vehicle being driven to an arrival point, according to an embodiment of the present disclosure. Referring to FIG. 1, the allocation management system for a vehicle being driven to an arrival point, according to an embodiment of the present disclosure, includes a passenger terminal 100, a management server 200, and a driver terminal 300.

The passenger terminal 100 is a wireless communication terminal, such as a smart phone, possessed by a passenger calling a vehicle 10 via an allocation management service of the vehicle being driven to the arrival point, according to an embodiment of the present disclosure, and the driver terminal 300 is a wireless communication terminal, such as a smart phone, possessed by a driver receiving allocation of his/her vehicle 10 via the corresponding service.

It is preferable that a passenger application program and a driver application program required to use the allocation management service of the vehicle being driven to the arrival point, according to an embodiment of the present disclosure, are respectively installed in the passenger terminal 100 and the driver terminal 300.

In implementing the present disclosure, the driver terminal 300 may be a communication terminal for supporting an operation of a navigation device or the like installed in the vehicle 10 of the driver.

Meanwhile, the driver terminal 300 may be distinguished into an operating driver terminal 300-1, which is the driver terminal 300 possessed by a driver driving an operating vehicle 10-1, which is the vehicle 10 being driven to the arrival point, and a standing-by driver terminal 300-2, which is the driver terminal 300 possessed by a driver driving a standing-by vehicle 10-2, which is the vehicle 10 standing by for a passenger or roaming without a determined arrival point.

In addition, in implementing the present disclosure, the arrival point of the operating vehicle 10-1 may be a returning place of the driver who finished the day's operation or a garage where the driver has to return the operating vehicle 10-1, and in this case, the present disclosure may be the allocation management method for a returning vehicle.

Also, in implementing the present disclosure, the arrival point of the operating vehicle 10-1 may be a destination of a passenger riding in the operating vehicle 10-1, and in this case, the present disclosure may be the allocation management method for sharing the operating vehicle 10-1.

Meanwhile, the management server 200 is a server installed and operated by a business operator providing the allocation management service for the vehicle being driven to the arrival point, according to an embodiment of the present disclosure, and the management server 200 receives, from the driver terminal 300, driving information including current location information of the operating vehicle 10-1 and arrival point information of the operating vehicle 10-1, receives, from the passenger terminal 100, passenger information including departure point information and destination information of a passenger, and determines allocation of the operating vehicle 10-1 by determining whether matching between the operating vehicle 10-1 and the passenger is suitable, based on the driving information and passenger information.

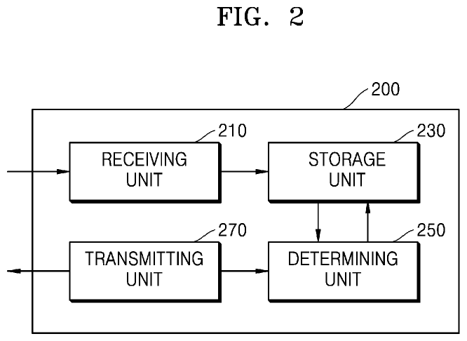

FIG. 2 is a functional block diagram showing a structure of the management server 200 for executing the allocation management method for the vehicle being driven to the arrival point, according to an embodiment of the present disclosure. Referring to FIG. 2, the management server 200 for executing the allocation management method for the vehicle being driven to the arrival point, according to an embodiment of the present disclosure, includes a receiving unit 210, a storage unit 230, a determining unit 250, and a transmitting unit 270.

The receiving unit 210 of the management server 200 receives, from the operating driver terminal 300-1, the driving information including the current location information of the operating vehicle 10-1 and the arrival point information of the operating vehicle 10-1, and receives, from the passenger terminal 100, the passenger information including the departure point information and the destination information of the passenger.

The determining unit 250 of the management server 200 determines allocation of the operating vehicle 10-1 by determining whether the matching between the operating vehicle 10-1 and the passenger is suitable, based on the driving information and the passenger information, and in detail, the determining unit 250 of the management server 200 determines whether the matching between the operating vehicle 10-1 and the passenger is suitable by determining whether a difference value between a total estimated travel time obtained by adding an estimated travel time from a current location to the operating vehicle 10-1 to a departure point of the passenger, an estimated travel time from the departure point of the passenger to a destination of the passenger, and an estimated travel time from the destination of the passenger to the arrival point of the operating vehicle 10-1, and an estimated travel time from the current location of the operating vehicle 10-1 to the arrival point of the operating vehicle 10-1 is less than a predetermined reference value.

The transmitting unit 270 of the management server 200 transmits the passenger information including the departure point information and destination information of the passenger to the driver terminal 300 of the vehicle 10 matched with the passenger.

Various types of reception information at the receiving unit 210, various types of determination information at the determining unit 250, and various types of transmission information at the transmitting unit 270 are accumulated and stored in the storage unit 230 of the management server 200, according to time periods.

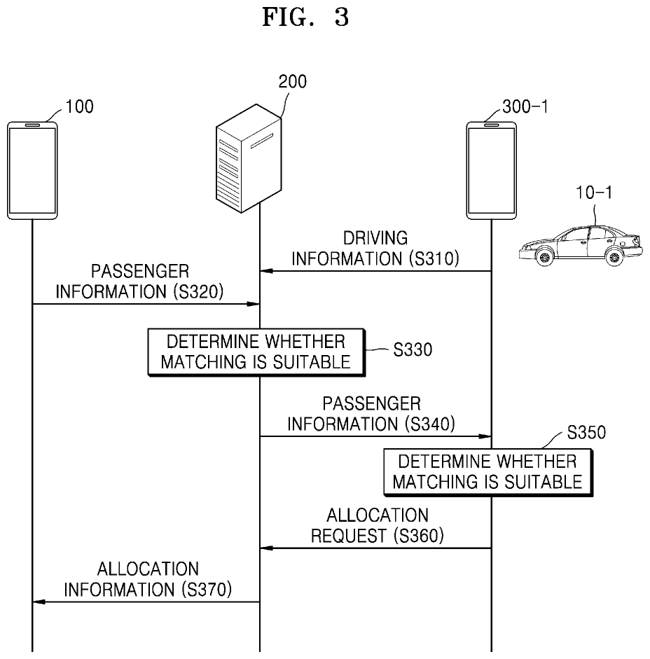

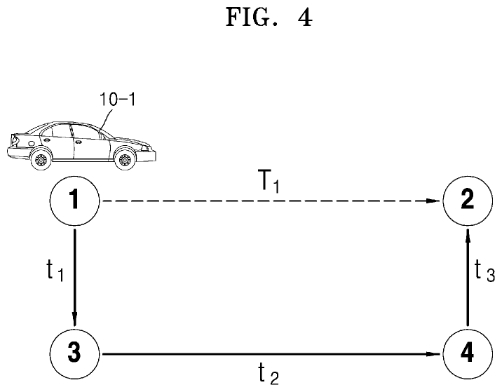

FIG. 3 is a signal flow diagram for describing an execution process of the allocation management method for the vehicle being driven to the arrival point, according to an embodiment of the present disclosure, and FIG. 4 is a conceptual diagram for describing an execution principle of the allocation management method for the vehicle being driven to the arrival point, according to an embodiment of the present disclosure.

Hereinafter, the execution process of the allocation management method for the vehicle being driven to the arrival point, according to an embodiment of the present disclosure, will be described with reference to FIGS. 1 to 4.

Referring to FIG. 3, the management server 200 receives, from the operating driver terminal 300-1 of the driver driving the vehicle 10-1 to the arrival point (the garage or the destination of the passenger), the driving information including the current location information of the operating vehicle 10-1 and the arrival point information of the operating vehicle 10-1 (operation S310).

Meanwhile, when the passenger executes the passenger application program installed in the passenger terminal 100 to call the vehicle 10 and inputs departure point location information and destination location information to the application program, the management server 200 receives, from the passenger terminal 100, the passenger information (i.e., a vehicle call request) including the departure point location information and the destination location information of the passenger (operation S320).

The determining unit 250 of the management server 200 determines whether matching between the operating vehicle 10-1 and the passenger is suitable, based on the driving information of the operating vehicle 10-1 received from the operating driver terminal 300-1, and the passenger information received from the passenger terminal 100 (operation S330).

In detail, as shown in FIG. 4, the determining unit 250 of the management server 200 may calculate each of an estimated travel time t1 from a current location 1 of the operating vehicle 10-1 to a departure point 3 of the passenger, an estimated travel time t2 from the departure point 3 of the passenger to a destination 4 of the passenger, and an estimated travel time t3 from the destination 4 of the passenger to an arrival point 2 of the operating vehicle 10-1, determine whether a difference value between a total estimated travel time (t1+t2+t3) obtained by adding the same and an estimated travel time T1 from the current location 1 of the operating vehicle 10-1 to the arrival point 2 of the operating vehicle 10-1 is less than a predetermined first reference value α (for example, 10 minutes), and when it is determined that the difference value is less than the predetermined first reference value α (i.e., when Equation 1 is satisfied), determine that the matching between the operating vehicle 10-1 and the passenger is suitable.

[(t₁−t₂−t₃)−T₁]<α [Equation 1]

Meanwhile, in implementing the present disclosure, the determining unit 250 of the management server 200 may calculate the estimated travel time T1 from the current location 1 of the operating vehicle 10-1 to the arrival point 2 of the operating vehicle 10-1, based on the current location information and arrival point information of the operating vehicle 10-1 included in the driving information of the operating vehicle 10-1 received from the operating driver terminal 300-1. However, the driving information received by the management server 200 from the operating driver terminal 300-1 in operation S310 may further include information on the estimated travel time T1 from the current location 1 of the operating vehicle 10-1 to the arrival point 2 of the operating vehicle 10-1, which is calculated by the application program installed in the operating driver terminal 300-1, and in this case, the determining unit 250 of the management server 200 may determine whether Equation 1 is satisfied by using the information on the estimated travel time T1 received from the operating driver terminal 300-1.

In detail, a case where Equation 1 is satisfied is a case where a time additionally taken when the driver changes a moving path to the arrival point 2 of the operating vehicle 10-1 to a moving path of sequentially passing the departure point 3 of the passenger and the destination 4 of the passenger is less than the predetermined first reference value α (for example, 10 minutes), and the determining unit 250 of the management server 200 determines that the matching between the operating vehicle 10-1 and the passenger is suitable by determining that this case is within a range tolerable by the driver of the operating vehicle 10-1 or the passenger on the operating vehicle 10-1.

In addition, in implementing the present disclosure, the determining unit 250 of the management server 200 may determine that the matching between the operating vehicle 10-1 and the passenger is suitable when the estimated travel time t1 from the current location 1 of the operating vehicle 10-1 to the departure point 3 of the passenger is less than a predetermined second reference value β, for example, 3 minutes (i.e., when Equation 2 is satisfied).

t_{1<β} [Equation 2]

In detail, a case where Equation 2 is satisfied is a case where the time t1 taken for the driver to deviate from an original moving path ((1)→(2)) and arrive at the departure point 3 of the passenger so as to take the passenger is less than the predetermined second reference value β, for example, 3 minutes, and the determining unit 250 of the management server 200 determines that the matching between the operating vehicle 10-1 and the passenger is suitable by determining that this case is within a range tolerable by the driver of the operating vehicle 10-1 or an existing passenger of the operating vehicle 10-1.

In addition, in implementing the present disclosure, the determining unit 250 of the management server 200 may determine that the matching between the operating vehicle 10-1 and the passenger is suitable when a distance D from the destination 4 of the passenger to the arrival point 2 of the operating vehicle 10-1 is less than a predetermined third reference value γ, for example, 2 km (i.e., when Equation 3 is satisfied).

D<γ [Equation 3]

In detail, a case where Equation 3 is satisfied is a case where the distance D the driver who completed driving to the destination 4 of the passenger has to move to the arrival point 2 from the original moving path is less than the predetermined third reference value γ, for example, 2 km, and the determining unit 250 of the management server 200 determines that the matching between the operating vehicle 10-1 and the passenger is suitable by determining that this case is within a range tolerable by the driver of the operating vehicle 10-1 or the existing passenger of the operating vehicle 10-1.

Meanwhile, in implementing the present disclosure, the determining unit 250 of the management server 200 may determine that the matching between the operating vehicle 10-1 and the passenger is suitable when Equation 1 is satisfied, when Equation 1 and Equation 2 are simultaneously satisfied, when Equation 1 and Equation 3 are simultaneously satisfied, or when Equations 1 to 3 are simultaneously satisfied, according to a setting condition of a manager.

In addition, in implementing the present disclosure, the driver may personally set a passenger matching condition as described above, via the operating driver terminal 300-1. In detail, the driver may select one or at least two equations to be necessarily satisfied from among three equations above, such that matching with the passenger is determined to be suitable, according to his/er tendency and situation.

Also, in implementing the present disclosure, the driver is able to not only personally select an equation as described above as the passenger matching condition via the operating driver terminal 300-1, but also personally set a first reference value, a second reference value, and a third reference value in each equation, according to his/her tendency and situation.

Information about the passenger matching condition and a reference value personally set by the driver as such may be transmitted from the operating driver terminal 300-1 to the management server 200, together with the driving information of the operating vehicle 10-1 in operation S310, and accordingly, the determining unit 250 of the management server 200 determines whether the matching with the passenger is suitable in operation S330, based on the information about the passenger matching condition and reference value set by the driver.

Meanwhile, the management server 200 transmits the passenger information including the departure point location information and destination location information of the passenger received from the passenger terminal 100 in operation S320, to at least one operating driver terminal 300-1 that transmitted the driving information, which is determined to be suitable for matching with the passenger in operation S330, from among the plurality of operating driver terminals 300-1 that transmitted the driving information to the management server 200 in operation S310 (operation S340).

In implementing the present disclosure, the application program installed in the operating driver terminal 300-1 may perform matching suitability determination independently from matching suitability determination by the determining unit 250 of the management server 200 in operation S330 (operation S350).

In detail, in implementing the present disclosure, the matching suitability determination between the passenger and the operating vehicle 10-1 may not be performed by the management server 200, but may be performed only by the operating driver terminal 300-1.

Also, in implementing the present disclosure, even when the matching suitability determination performed by the determining unit 250 of the management server 200 has passed according to information about a passenger matching condition and reference values set by a manager, the driver may finally perform the matching suitability determination additionally according to the information about the passenger matching condition and reference values personally set according to his/her tendency and situation as described above, on the application program of the operating driver terminal 300-1.

In detail, the operating driver terminal 300-1 may calculate each of the estimated travel time t1 from the current location 1 of the operating vehicle 10-1 to the departure point 3 of the passenger, the estimated travel time t2 from the departure point 3 of the passenger to the destination 4 of the passenger, and the estimated travel time t3 from the destination 4 of the passenger to the arrival point 2 of the operating vehicle 10-1, determine whether the difference value between a total estimated travel time (t1+t2+t3) obtained by adding the same and the estimated travel time T1 from the current location 1 of the operating vehicle 10-1 to the arrival point 2 of the operating vehicle 10-1 is less than the predetermined first reference value α (for example, 5 minutes), and when it is determined that the difference value is less than the predetermined first reference value α (i.e., when Equation 1 is satisfied), determine that the matching between the operating vehicle 10-1 and the passenger is suitable.

In addition, the operating driver terminal 300-1 may determine that the matching between the operating vehicle 10-1 and the passenger is suitable when the estimated travel time t1 from the current location 1 of the operating vehicle 10-1 to the departure point 3 of the passenger is less than the predetermined second reference value β, for example, 2 minutes (i.e., when Equation 2 is satisfied).

In addition, in implementing the present disclosure, the operating driver terminal 300-1 may determine that the matching between the operating vehicle 10-1 and the passenger is suitable when the distance D from the destination 4 of the passenger to the arrival point 2 of the operating vehicle 10-1 is less than the predetermined third reference value γ, for example, 1 km (i.e., when Equation 3 is satisfied).

Also, the operating driver terminal 300-1 may determine whether the matching between the operating vehicle 10-1 and the passenger is suitable, according to at least one equation selected and set by the driver as a passenger matching requirement condition via the operating driver terminal 300-1 from among the three equations, and first through third reference values set by the driver in each equation.

When it is determined that the matching with the passenger is suitable in operation S350 described above, the operating driver terminal 300-1 transmits, to the management server 200, an allocation request including the current location information and arrival point information of the operating vehicle 10-1, and a license plate number of the operating vehicle 10-1 (operation S360).

Accordingly, the management server 200 transmits, to the passenger terminal 100, allocation information including the current location information and arrival point information of the operating vehicle 10-1 and the license plate number of the operating vehicle 10-1, which are included in the allocation request received from the operating driver terminal 300-1, thereby completing allocation of the operating vehicle 10-1 (operation S370).

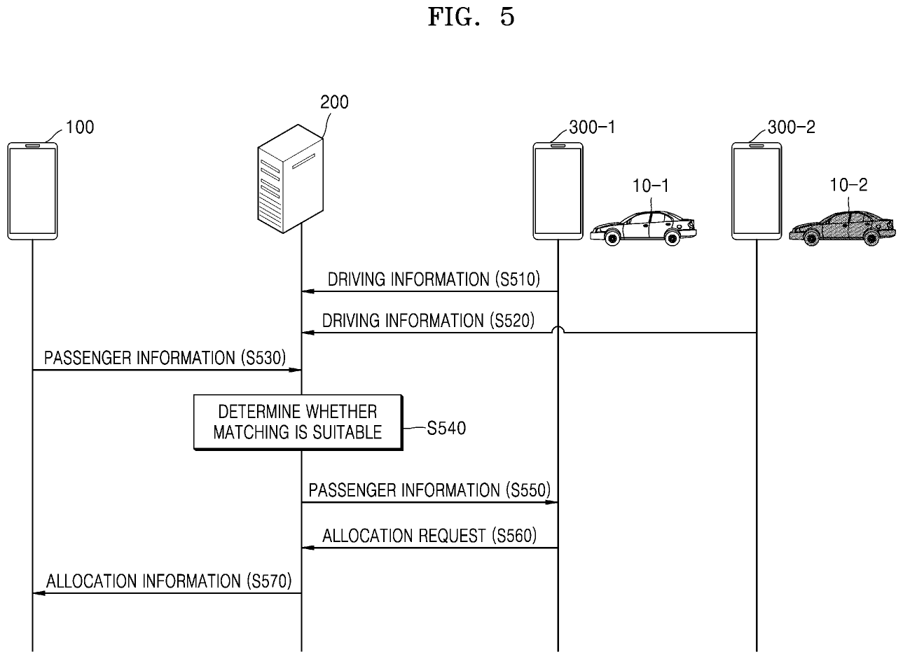

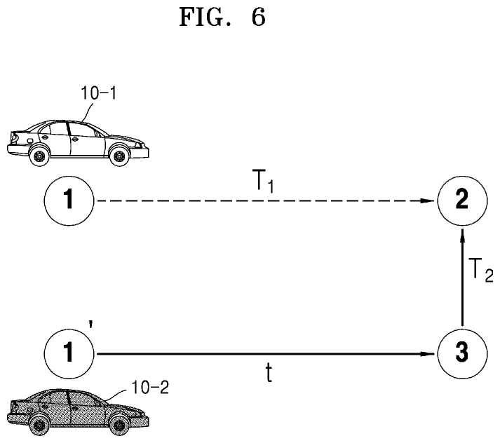

FIG. 5 is a signal flow diagram for describing an execution process of the allocation management method for the vehicle being driven to the arrival point, according to another embodiment of the present disclosure, and FIG. 6 is a conceptual diagram for describing the execution principle of the allocation management method for the vehicle being driven to the arrival point, according to another embodiment of the present disclosure.

Hereinafter, the execution process of the allocation management method for the vehicle being driven to the arrival point, according to another embodiment of the present disclosure, will be described with reference to FIGS. 1, 2, 5, and 6.

First, the management server 200 receives the driving information including the current location information of the operating vehicle 10-1 and the arrival point information of the operating vehicle 10-1, from the operating driver terminal 300-1 that is a terminal possessed by the driver driving the operating vehicle 10-1 that is a vehicle being driven to the arrival point with a passenger (operation S510).

Also, the management server 200 receives the driving information including the current location information of the standing-by vehicle 10-2 from the standing-by driver terminal 300-2 that is a terminal possessed by the driver driving the standing-by vehicle 10-2 that is a vehicle standing by for a passenger or roaming without a passenger (operation S520).

Meanwhile, when the passenger executes the passenger application program installed in the passenger terminal 100 to call the vehicle 10 and inputs the departure point location information and the destination location information to the application program, the management server 200 receives, from the passenger terminal 100, the passenger information (i.e., a vehicle call request) including the departure point location information and the destination location information of the passenger (operation S530).

Then, the determining unit 250 of the management server 200 determines and compares matching suitability between the operating vehicle 10-1 and the passenger and matching suitability between the standing-by vehicle 10-2 and the passenger, based on the passenger information received from the passenger terminal 100 and the driving information received from each of the operating driver terminal 300-1 and the standing-by driver terminal 300-2.

In detail, the determining unit 250 of the management server 200 calculates each of an estimated travel time T1 from the current location 1 of the operating vehicle 10-1 to the arrival point 2 of the operating vehicle 10-1 and an estimated travel time T2 from the arrival point 2 of the operating vehicle 10-1 to the departure point 3 of the passenger, and then calculates a final arrival estimated required time T1+T2 of the operating vehicle 10-1 to the departure point of the passenger, which is a moving time obtained by adding the estimated travel times T1 and T2.

Also, the determining unit 250 of the management server 200 calculates an arrival estimated required time t of the standing-by vehicle 10-2, i.e., an estimated travel time t from a current location 1′ of the standing-by vehicle 10-2 to the departure point 3 of the passenger.

Then, the determining unit 250 of the management server 200 compares the arrival estimated required time t of the standing-by vehicle 10-2 and the arrival estimated required time T1+T2 of the operating vehicle, and determines that the vehicle 10 having a shorter arrival estimated required time is more suitable to the passenger.

For example, when the arrival estimated required time T1+T2 (for example, 2 minutes) of the operating vehicle 10-1 is shorter than the arrival estimated required time t (for example, 3 minutes) of the standing-by vehicle 10-2, the determining unit 250 of the management server 200 determines allocation of the operating vehicle 10-1 prior to the standing-by vehicle 10-2.

As such, when the determining unit 250 of the management server 200 determines the allocation of the operating vehicle 10-1, the management server 200 transmits, to the operating driver terminal 300-1 of the matched operating vehicle 10-1, the passenger information (i.e., a vehicle call request) including the departure point location information and destination location information of the passenger, which are received from the passenger terminal 100 in operation S530 described above (operation S550).

Accordingly, the operating driver terminal 300-1 transmits the allocation request including the license plate number of the operating vehicle 10-1 to the management server 200 (operation S560), and the management server 200 completes the allocation of the operating vehicle 10-1 by transmitting, to the passenger terminal 100, the allocation information including the license plate number of the operating vehicle 10-1 included in the allocation request received from the operating driver terminal 300-1 (operation S570).

Meanwhile, the present disclosure may be executed while a program for executing each operation of the allocation management method for the vehicle being driven to the arrival point, according to the present disclosure described above, is installed in the storage unit 230 of the management server 200 and/or the driver terminal 300, and the program may be used by being recorded on a computer-readable recording medium.

According to an embodiment, the management server 200 may receive, from the operating driver terminal 300-1 of the driver driving the vehicle 10-1 to the arrival point (the garage or the destination of the passenger), the driving information including the current location information of the operating vehicle 10-1 and the arrival point information of the operating vehicle 10-1.

When a first passenger executes the passenger application program installed in a first passenger terminal to call the vehicle 10 and inputs first departure point information and first destination information to the application program, the management server 200 may receive, from the first passenger terminal, first passenger information (i.e., a vehicle call request) including the first departure point information and first destination information of the first passenger.

The management server 200 determines whether matching between the operating vehicle 10-1 and the passenger is suitable, based on the driving information of the operating vehicle 10-1 received from the operating driver terminal 300-1, and the passenger information received from the first passenger terminal. The management server 200 may determine the matching suitability according to the method described above in the present specification.

Also, the management server 200 may receive, from a second passenger terminal, second passenger information including second departure point information and second destination information of a second passenger.

The management server 200 may determine whether matching between the operating vehicle 10-1 and the second passenger is suitable, in response to obtaining vehicle sharing consent the first passenger and the second passenger.

Here, the first passenger is an existing passenger of the operating vehicle 10-1 and the second passenger is a new passenger of the operating vehicle 10-1. When at least one of the first passenger and the second passenger does not consent to sharing a vehicle, the management server 200 does not determine whether the matching between operating vehicle 10-1 and the second passenger is suitable.

To determine whether the matching between the operating vehicle 10-1 and the second passenger is suitable, the management server 200 may determine whether a difference value between a shortest moving time for passing a first departure point of the first passenger, a first destination, a second departure point of the second passenger, and a second destination once from a current location of the operating vehicle 10-1 and an estimated travel time from the current location of the operating vehicle 10-1 to an arrival point of the operating vehicle is less than the predetermined first reference value α, for example, 10 minutes, and when the difference value is less than the predetermined first reference value α, determine that the matching between the operating vehicle 10-1 and the second passenger is suitable.

Meanwhile, the first departure point and the first destination of the first passenger, and the second departure point and the second destination of the second passenger may all be different locations, or one of the first departure point and the first destination of the first passenger and one of the second departure point and the second destination of the second passenger may be a same location.

According to an embodiment, the management server 200 may delay a time when the first passenger, i.e., the existing passenger, arrives the destination, when the operating vehicle 10-1 and the second passenger, i.e., the new passenger, are matched. The management server 200 may calculate an arrival delay time of the first passenger when the operating vehicle 10-1 and the second passenger are matched.

The management server 200 may provide a reward to the first passenger, based on the calculated arrival delay time. The reward provided to the first passenger may be proportional to the arrival delay time.

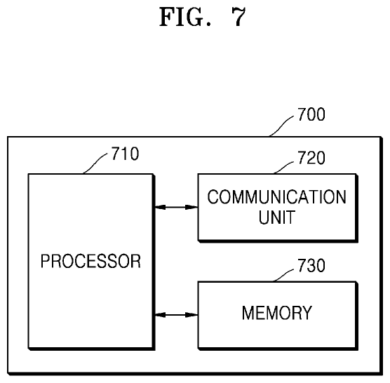

FIG. 7 is a block diagram of a management server according to an embodiment.

Referring to FIG. 7, a management server 700 may include a communication unit 720, a processor 710, and a database (DB) 730. Only components related to the embodiment are shown in the management server 700 of FIG. 7. Accordingly, it would be understood by one of ordinary skill in the art that other general-purpose components may be further included in addition to the components shown in FIG. 7.

The communication unit 720 may include one or more components for performing wired/wireless communication with an external server or an external device. For example, the communication unit 720 may include a short-range communication unit (not shown), a mobile communication unit (not shown), and a broadcast receiving unit (not shown).

The receiving unit 210 and the transmitting unit 270 described above in FIG. 2 may be implemented as the communication unit 720.

The DB 730 is hardware for storing various types of data processed in the management server 700, and may store a program for processes and controls by the processor 710. The DB 730 may store payment information, user information, and the like.

The DB 730 may include random access memory (RAM) such as dynamic random-access memory (DRAM) or static random-access memory (SRAM), read-only memory (ROM), electrically erasable programmable read-only memory (EEPROM), CD-ROM, Blu-ray or another optical disk storage, a hard disk drive (HDD), a solid-state drive (SSD), or a flash memory.

The storage unit 230 described above in FIG. 2 may be implemented as the DB 730.

The processor 710 controls overall operations of the management server 700. For example, the processor 710 may generally control an input unit (not shown), a display (not shown), the communication unit 720, the DB 730, and the like by executing programs stored in the DB 730. The processor 710 may control operation of the management server 700 by executing programs stored in the DB 730.

The processor 710 may be implemented by using at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and an electric unit for performing other functions.

The processor 710 may control at least some of the operations of the management server 700 described above with reference to FIGS. 1 to 6. The determining unit 250 described above in FIG. 2 may be implemented as the processor 710.

According to an embodiment, the management server 700 may be a server located outside a vehicle. The server may be implemented as a computer device or a plurality of computer devices that communicate via a network to provide commands, codes, files, content, services, and the like. The server may receive, from devices mounted on a vehicle, data necessary to determine a current lane on which the vehicle is being driven, and determine the current lane on which the vehicle is being driven, based on the received data.

According to another embodiment, the management server 700 may be implemented as an electronic device embedded in a vehicle. For example, the management server 700 may be implemented as an electronic device inserted into a vehicle via tuning after a production process.

According to another embodiment, the management server 700 may be implemented as an electronic device having mobility. For example, the management server 700 may be implemented as a smart phone, a tablet personal computer (PC), a PC, a smart television (TV), a personal digital assistant (PDA), a laptop computer, a media player, a navigation device, a device equipped with a camera, or another mobile electronic device. Also, the management server 700 may be implemented as a wearable device, such as a watch, glasses, a hair band, or a ring, having a communication function and a data processing function.

Also, terms used in the present disclosure are only used to describe specific embodiments, and are not intended to limit the present disclosure. An expression used in the singular encompasses the expression in the plural, unless it has a clearly different meaning in the context. In the present specification, it is to be understood that terms such as “including”, “having”, etc., are intended to indicate the existence of features, numbers, steps, operations, components, parts, or combinations thereof described in the specification, and are not intended to preclude the possibility that one or more other features, numbers, steps, operations, components, parts, or combinations thereof may exist or may be added.

While embodiments and application examples of the present disclosure have been illustrated and described above, the present disclosure is not limited by specific embodiments and application examples described above, and various modifications may be feasible by a one of ordinary skill in the art without departing from the gist of the present disclosure claimed in the claims. Also, these modifications should not be understood separately from the technical ideas or prospects of the present disclosure.

1. An allocation management method for a vehicle being driven to an arrival point, the allocation management method comprising:
(a) receiving, by a management server, driving information including current location information of an operating vehicle and arrival point information of the operating vehicle, from a driver terminal;
(b) receiving, by the management server, passenger information including departure point information and destination information of a passenger, from a passenger terminal; and
(c) determining, by the management server, whether matching between the operating vehicle and the passenger is suitable, based on the driving information and the passenger information.

2. The allocation management method of claim 1, wherein the (c) determining comprises (c1) determining, by the management server, whether a difference value between a total estimated travel time obtained by adding an estimated travel time from a current location to the operating vehicle to a departure point of the passenger, an estimated travel time from the departure point of the passenger to a destination of the passenger, and an estimated travel time from the destination of the passenger to an arrival point of the operating vehicle, and an estimated travel time from the current location of the operating vehicle to the arrival point of the operating vehicle is less than a predetermined reference value.

3. The allocation management method of claim 2, wherein the (c) determining further comprises (c2) determining, by the management server, whether the estimated travel time from the current location of the operating vehicle to the departure point of the passenger is less than a predetermined reference value.

4. A management server comprising:
a receiving unit configured to receive, from a driver terminal, driving information including current location information of an operating vehicle and arrival point information of the operating vehicle, and receive, from a passenger terminal, passenger information including departure point information and destination information of the passenger; and
a determining unit configured to determine whether matching between the operating vehicle and the passenger is suitable, based on the driving information and the passenger information.

5. The management server of claim 4, wherein the determining unit is further configured to determine whether a difference value between a total estimated travel time obtained by adding an estimated travel time from a current location to the operating vehicle to a departure point of the passenger, an estimated travel time from the departure point of the passenger to a destination of the passenger, and an estimated travel time from the destination of the passenger to an arrival point of the operating vehicle, and an estimated travel time from the current location of the operating vehicle to the arrival point of the operating vehicle is less than a predetermined reference value.

6. The management server of claim 5, wherein the determining unit is further configured to determine whether the estimated travel time from the current location of the operating vehicle to the departure point of the passenger is less than a predetermined reference value.

7. An allocation management method for a vehicle being driven to an arrival point, the allocation management method comprising:
(a) receiving, by a driver terminal, passenger information including departure point information and destination information of a passenger, from a management server; and
(b) determining, by the driver terminal, whether to approve boarding of the passenger, based on the passenger information and driving information including current location information of an operating vehicle driven by a driver and arrival point information of the operating vehicle.

8. The allocation management method of claim 7, wherein the (b) determining comprises (b1) determining, by the driver terminal, whether a difference value between a total estimated travel time obtained by adding an estimated travel time from a current location to the operating vehicle to a departure point of the passenger, an estimated travel time from the departure point of the passenger to a destination of the passenger, and an estimated travel time from the destination of the passenger to an arrival point of the operating vehicle, and an estimated travel time from the current location of the operating vehicle to the arrival point of the operating vehicle is less than a predetermined reference value.

9. The allocation management method of claim 8, wherein the (b) determining further comprises (b2) determining, by the driver terminal, whether the estimated travel time from the current location of the operating vehicle to the departure point of the passenger is less than a predetermined reference value.

10. A recording medium having recorded thereon a program for executing the method according to claim 1.
